(19) United States
(12) Patent Application Publication
(10) Pub. No.: US 2011/0192331 A1
(43) Pub. Date: Aug. 11, 2011

(54) PLANTING UNIT COMPRISING A POINTED MEMBER MOUNTED BETWEEN TWO DISCS FOR OPENING A FURROW, AND MEANS FOR RELEASING SAID MEMBER WITHOUT REMOVING DISCS

(75) Inventor: Caroline Bergere, Bressuire (FR)

(73) Assignee: RIBOULEAU MONOSEM, Largeasse (FR)

(21) Appl. No.: 13/023,277

(22) Filed: Feb. 8, 2011

(30) Foreign Application Priority Data
Feb. 11, 2010 (FR) FR 10/00563

(51) Int. Cl. A01C 5/06

(52) U.S. Cl. 111/164

(57) ABSTRACT

Described herein is a planting unit that includes a frame whereon are mounted:
means of opening a furrow in the ground, in the form of two adjacent discs;
a pointed member removably mounted on said frame and protruding between said two discs and in the direction of the ground, said member being intended to form said furrow in a V shape,
means of retaining said member mounted mobile on said frame between a retaining position of said member and a releasing position; and
means of actuating connected to said means of retaining

### CROSS-REFERENCE TO RELATED APPLICATIONS

This application claims priority to French Patent Application No. FR 10/00563, filed Feb. 11, 2010, the disclosure of which is incorporated by reference herein.

### FIELD OF THE INVENTION

The field of the invention is that of the design and manufacture of agricultural machines. More precisely, the invention relates to a planting unit, in particular single-seed, intended to be towed or carried, and comprising a frame whereon are in particular mounted a reservoir of seeds and a distributor of said seeds.

The invention applies in particular to the field of single-seed sowing, for example for the cultivation of corn, beets and sunflower, for which the seeds are implanted individually, by complying with a spacing and a predetermined setting into place between the seeds deposited in the furrow.

### BACKGROUND OF THE INVENTION

Planting units include, in general, a frame supporting a reservoir of seeds and a seed distributor from the reservoir, as well as means of opening a furrow in the ground, the seeds having to be deposited in the furrow created by the unit.

Such units are intended, individually or by group, to be mounted on a chassis, which is in turn towed by a farm tractor.

Currently, the means for opening the furrows are divided into two categories:
shares;
pair of discs, commonly called “dual-disk”.

Shares form relatively compact and inexpensive members for carrying out furrows. In addition, they make it possible to “cleanly” configure the furrows: the furrows have a well-designed V-shaped section, which makes it possible to obtain a very regular furrow depth.

However, the shares have in particular the disadvantages of:
proceeding with “lifting” soil, which implies moving on a relatively loose soil worked beforehand, i.e. ploughed;
generate relatively substantial resistances when the soil is wet, the shares having a tendency to bring up the sticky soil which can agglutinate in front of the share and as thus form a brake.

With the passing of time, the practice of ploughing is becoming lost or, at least, is decreasing considerably. The soil is therefore little prepared, even not prepared, and work must be done with a soil that is harder at the time of sowing the seeds.

In particular, non-ploughed soil has a relatively substantial resistance to the operation of opening the furrow with conventional shares.

To this effect, dual-disk furrow opening devices have been developed. In these devices, the discs occupy relative positions and inclinations allowing to form a furrow not by lifting of the soil as is the case with the share, but through a process that is more similar to an operation of cutting the soil.

With these dual-disc devices, furrows can therefore be opened in harder soils and/or wet soils.

Furthermore, the discs can correctly operate the opening of the furrow including in the case of the presence of plant residues on the ground, which is not the case with conventional shares with which the plant residues tend to become wedged in front of the share and degrade the quality of the furrow.

However, these dual-disc devices tend alone to generate furrows of which the section has a W shape, rather than a V shape.

This results in that the seed, according to the location where it is deposited into the furrow, i.e. completely at the bottom of the furrow or on the median tip of the W, is not deposited at a constant height, which is however a determining parameter for the later development of the plant.

As such, a pointed member is generally added to the pair of discs which tends to eliminate the median tip of the W-shape of the furrow, in order to bring the latter the desired V-shape.

This member is arranged between the discs.

Of course, this pointed member tends to wear with the passing of time, and therefore become blunt. With wear, the action of this pointed member is not optimal: the furrow obtained has a flat bottom, providing the furrow with a section of trapezoidal shape. Such a shape of furrow is a disadvantage in that the seed released by the distributor, under the effect of the speed of progression of the unit, can roll on the flat bottom of the furrow. Then there is no longer any control of the distance between the seeds, this distance also however being a determining parameter in the development and the later quality of the plant.

Moreover, the pointed members are, for the same planting unit, available in several different models, each adapted to a type of ground. The farmer must select and mount the pointed members that are best adapted to the soil that he is going to work with.

For one and/or the other of the reasons that have just been indicated, this pointed member must be replaced on a regular basis. Of course, the latter is movably mounted on the frame of the planting unit. Conventionally, the pointed member is fixed on the frame in an area of the frame extending between the two corresponding discs. So at least one of the two discs, if not both, must be removed in order to proceed with replacing the pointed member. It is generally necessary to remove in addition at least one of the depth wheels that the planting unit comprises.

Such an operation is relatively long and it is common that the farmer, therefore, neglects to replace the pointed members.

### SUMMARY OF THE INVENTION

The invention has in particular for objective to overcome this disadvantage of prior art.

More precisely, the invention has for objective to propose a planting unit for seeds, in particular for single-seed sowing of the type implementing means of opening of furrows in the form of two adjacent discs, and a pointed member movably mounted on the frame between the two discs, which makes possible easy and rapid replacing of said pointed member.

These objectives, as well as others which shall appear in what follows, are achieved thanks to the invention which has for object a planting unit, comprising a frame whereon are mounted:
means of opening a furrow in the ground, in the form of two adjacent discs;
a pointed member removably mounted on said frame and protruding between said two discs and in the direction of the ground, said member being intended to form said furrow in a V shape,

characterised in that it comprises:
means of retaining said member mounted mobile on said frame between a retaining position of said member and a releasing position;
means of actuating connected to said means of retaining

As such, thanks to the invention, the replacing of the pointed member can be carried out without it being necessary to remove one of the two discs, or even both of the discs.

Indeed, as it will appear more clearly in what follows, it is possible for an operator to directly access the means of actuating connected to the means of retaining in order to release the pointed member, the latter able to be grasped by the operator in that it protrudes between the discs and in the direction of the ground. As the operation of replacing pointed members can be carried out rapidly and easily, the farmer is encouraged to proceed with this operation whenever necessary.

As explained hereinabove, the regular replacing of the pointed members allows the farmer to obtain furrows of optimised shape in order to guarantee the deposit of seeds at a constant height and with a constant separation, or almost, between the seeds at the bottom of the furrow.

According to an advantageous solution, said pointed member has an upper portion intended to cooperate according to a male/female connection with means of complementary shape integral with said frame extending between said discs.

A sort of guiding is therefore obtained facilitating the installation of the pointed member on the frame.

Preferentially, said pointed member forms a male element and said means of complementary shape constitutes a female element intended to cooperate with said pointed member.

Of course, it is also conceivable, according to another embodiment that can be considered, that it be the pointed member which forms a female element, the means of complementary shape then being formed as a male element of the male/female connection.

According to a preferred embodiment, said member has at least one elongated upper portion, said frame having between said discs at least one sleeve wherein said elongated upper portion is intended to come to be housed and to be retained therein by said means of retaining.

In this case, said elongated portion comprises at least one notch, said means of retaining comprising at least one lug intended to be brought in said notch in order to retain said pointed member on said frame.

In this way, the pointed member is introduced by sliding in the sleeve of the frame and, once the lug introduced into the notch of the elongated portion, it is no longer possible to proceed with the sliding of the elongated portion of the pointed member in the sleeve. The maintaining of the pointed member on the frame is as such obtained.

According to a particular solution, said lug is carried by an actuating head mounted mobile on an extension of said sleeve.

Advantageously, said actuating head is mobile in the direction of said releasing position of said means of retaining against means of elastically deformable recalling.

As such, by default, the means of retaining are constrained to exert a force that maintains the pointed member on the frame.

Preferentially, said means of elastically deformable recalling are carried by said extension.

According to another advantageous characteristic, an actuation lever extends from said actuating head.

### BRIEF DESCRIPTION OF THE DRAWINGS

Other characteristics and advantages of the invention shall appear more clearly when reading the following description of a preferred embodiment of the invention, provided as a simple and non restrictive example, and of the annexed drawings wherein:

FIG. 1 is a view of a planting unit according to the invention;

FIG. 2 is a detailed view of means of retaining a pointed member between two discs of the opening of a furrow, in retaining position of the pointed member;

FIG. 3 is a detailed view of means of retaining of a pointed member between two discs of the opening of a furrow, in releasing position of the pointed member.

### DETAILED DESCRIPTION OF THE INVENTION

Such as indicated hereinabove, the principle of the invention resides in the fact of providing a planting unit, in particular single-seed, of the type comprising means of opening a furrow in the form of two adjacent discs with a pointed member mounted between the two discs, with means of retaining the pointed member and means of actuating means of retaining making it possible to proceed with the replacing of the pointed member without removal of one of the two discs or even of both discs.

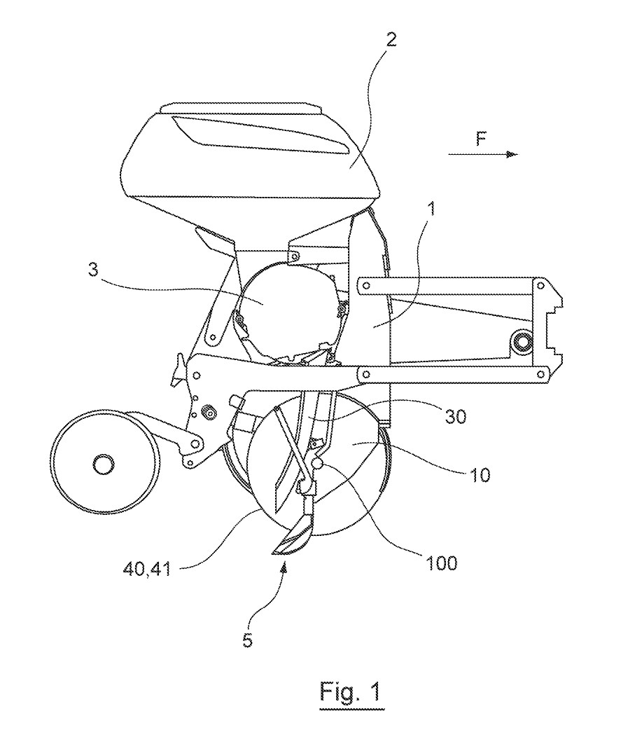

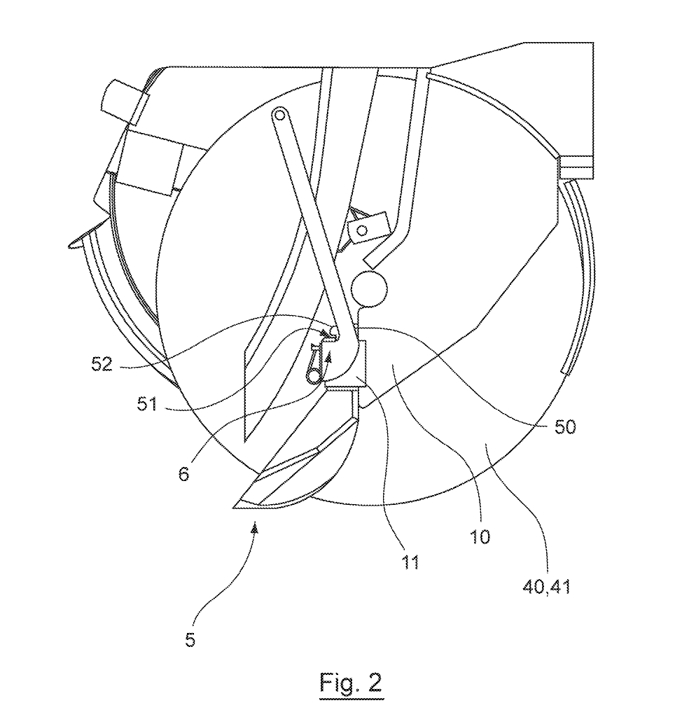

In reference to FIGS. 1 and 2, a planting unit according to this embodiment of the invention comprises a frame 1 whereon are mounted:
a reservoir of seeds 2;
a seed distributor 3, comprising a distributing chute 30;
the means of opening a furrow in the ground, in the form of two adjacent discs 40, 41;
a pointed member 5, mounted between the two discs 40, 41 and protruding between the latter in the direction of the ground.

The seed distributor is of the type implementing a single-seed pneumatic device adapted to recover via air vacuum a seed from the reservoir 2, and to then allow this seed to drop into the distributing chute 30.

The frame 1 comprises a plate 10 extending between the discs 40, 41. This plate 10 carried the axes 100 whereon are mounted the discs 40, 41.

Furthermore, the pointed member 5 is removably mounted on this plate 10.

According to the principle of the invention, the unit has in addition:
means of retaining de the pointed member 5, mounted mobile between a retaining position and a releasing position de the pointed member;
means of actuating connected to the means of retaining.

The means of retaining and the means of actuating are described in more detail hereinafter.

According to this embodiment, the pointed member 5 has an elongated upper portion 50 and, in parallel, the plate 10 carries a sleeve 11 of which the internal dimensions correspond substantially, with close play, to the external dimensions of the upper portion 50 of the pointed member.

Constituted as such, the upper portion of the pointed member cooperates with the sleeve, forming a means of complementary shape of the upper portion of the pointed member, according to a male/female connection, the upper portion comprising a male element and the sleeve a female element in the male/female connection.

The mounting of the pointed member on the frame is therefore carried out by press fitting the elongated upper portion 50 into the sleeve 11 integral with the frame, the means of retaining being then brought into a position according to which they retain the pointed member on the sleeve such as described hereinafter.

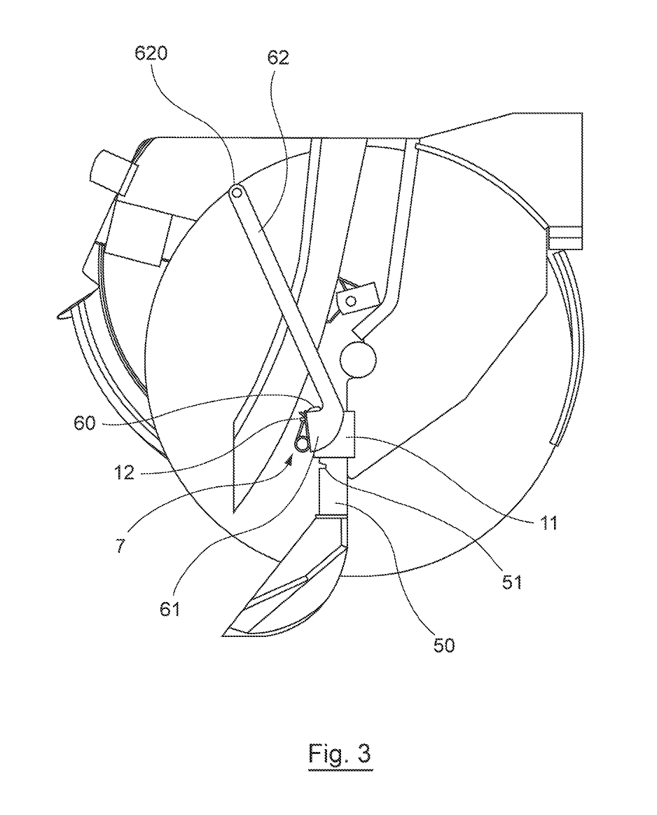

In reference to FIGS. 2 and 3, the upper portion 50 of the pointed member has a notch 51 and the means of retaining 6 include a lug 60 intended to be brought in the notch 51 in order to ensure the retaining of the pointed member on the frame.

Note that the notch 51 is arranged in the vicinity of the upper end of the upper portion 50 of the pointed member, and that this upper portion of the pointed member has a length such that the upper portion fully passes through the sleeve 11 in such a way as to have the notch 51 above the sleeve 11.

Such as is shown in FIGS. 2 and 3, the lug 60 is carried by an actuating head 61 mounted mobile on the sleeve 51 integral with the frame.

This actuating head 61 has a U-shaped section of which the internal dimensions correspond substantially, with close play, to the external dimensions of the sleeve 11, the actuating head being mounted on the sleeve according to a sliding nesting.

In addition, the sleeve 11 has an extension 12 in the form of a prong, the actuating head 61 having a recess allowing for the passage of this extension. Such as is shown in FIGS. 2 and 3, once the actuating head is mounted on the sleeve 11, the extension 12 protrudes from the actuating head. During the actuating of the means of retaining, the actuating head slides in its upper portion over the extension.

Furthermore, means of elastic recalling 7 are mounted on the portion protruding from the extension 12, through an orifice arranged in the extension 12. These means of elastic recalling are designed and mounted in order to exert a constraint on the actuating head 61, tending to repel the latter into a retaining position of the pointed member on the frame. In other words, the actuating head is mobile in the direction of the releasing position of the lug 60 against the action of the means of elastically deformable recalling 7.

Moreover, an actuation lever 62 extends from the actuating head, in such a way as to have a free end 620 that is accessible for an operator.

The replacing of a pointed member in a planting unit according to the invention is carried out in the following way.

The operator accesses the free end 620 of the actuation lever 62, either directly or by the intermediary of a hook that he inserts in an orifice arranged in the vicinity of the free end 620, in such a way as to exert a traction towards the rear on the actuation lever 62 (being considered the direction of progress indicated by the arrow F in FIG. 1).

By pulling towards the rear on the actuation lever, the operator releases the lug 60 of the notch 51 of the upper portion 50 of the pointed member, this against the action of the means of elastically deformable recalling 7.

In the absence of any retaining action, the pointed member is released from the sleeve 11 under the simple effect of gravity. Due to possible clogging, it is possible that the operator has to grasp the pointed member and exert on it fraction downwards in order to release it from the sleeve 11.

The operator can then install a new pointed member: the elongated upper portion of the pointed member is introduced into the sleeve 11 (the planting unit is able to be tipped into a raised position in order to proceed with the replacing of the pointed members, allowing the operator to view the sleeves between the discs), this by sliding the upper portion in the sleeve until the latter fully passes through the sleeve. As the end 52 of the upper portion 50 of the pointed member has a rounded shape, the latter forms a sort of cam acting on the lug 60 in such a way as to repel the latter. The operator continues to push the pointed member inside the sleeve 11, thus until the notch 51 is brought into correspondence with the lug 60, which then penetrates the notch 51 under the effect of the force exerted by the means of elastically deformable recalling 7 on the actuating head 61.

What is claimed is:

1. A planting unit, comprising a frame whereon are mounted:
means of opening a furrow in the ground, in the form of two adjacent discs;
a pointed member removably mounted on said frame and protruding between said two discs and in the direction of the ground, said member being intended to form said furrow in a V shape,
means of retaining said member mounted mobile on said frame between a retaining position of said member and a releasing position;
means of actuating connected to said means of retaining.

2. The planting unit according to claim 1, wherein said pointed member has an upper portion intended to cooperate according to a male/female connection with means of complementary shape integral with said frame extending between said discs.

3. The planting unit according to claim 1, wherein said pointed member forms a male element and in that said means of complementary shape form a female element intended to cooperate with said pointed member.

4. The planting unit according to claim 1, wherein said member has at least one elongated upper portion, said frame having between said discs at least one sleeve wherein said elongated upper portion is intended to come to be housed and to be retained therein by said means of retaining.

5. The planting unit according to claim 4, wherein said elongated portion comprises at least one notch, said means of retaining comprising at least one lug intended to be brought in said notch in order to retain said pointed member on said frame.

6. The planting unit according to claim 5, wherein said lug is carried by an actuating head mounted mobile on an extension of said sleeve.

7. The planting unit according to claim 6, wherein said actuating head is mobile in the direction of said releasing position of said means of retaining against means of elastically deformable recalling.

8. The planting unit according to claim 7, wherein said means of elastically deformable recalling are carried by said extension.

9. The planting unit according to claim 6, wherein an actuation lever extends from said actuating head.
